(19) United States
(12) Patent Application Publication
(10) Pub. No.: US 2018/0010459 A1
(43) Pub. Date: Jan. 11, 2018

(54) LOW ENERGY WAKE STAGE

(71) Applicant: UNITED TECHNOLOGIES CORPORATION, Farmington, CT (US)

(72) Inventors: CHARLES P. GENDRICH, Middletown, CT (US); CHARLES H. ROCHE, Tolland, CT (US)

(73) Assignee: UNITED TECHNOLOGIES CORPORATION, Farmington, CT (US)

(21) Appl. No.: 15/402,629

(22) Filed: Jan. 10, 2017

Related U.S. Application Data
(60) Provisional application No. 62/277,175, filed on Jan. 11, 2016.

(51) Int. Cl. F01D 5/06; F01D 5/34; F01D 9/04

(52) U.S. Cl. CPC F01D 5/06; F01D 9/041; F01D 5/34; F05D 2220/32; F05D 2240/30; F05D 2260/961; F05D 2240/128

(57) ABSTRACT

The leading edge, the trailing edge, or both may be axially offset for a portion of the airfoils in a disk. By offsetting the airfoils, the downstream wake energy to the next stage of airfoils may be decreased. By staggering airfoils which are offset with airfoils that are not offset, the wake shapes from the airfoils may be out of phase and will not excite the downstream airfoils as much as conventional systems. This may decrease vibration and associated vibratory stresses in the system.

### CROSS REFERENCE TO RELATED APPLICATION

The present application claims benefit to, U.S. Provisional Application No. 62/277,175 entitled “LOW ENERGY WAKE STAGE” and filed on Jan. 11, 2016, the contents of which are incorporated by reference herein in their entirety.

### FIELD

The disclosure relates generally to gas turbine engines, and more particularly to rotor configurations in gas turbine engines.

### BACKGROUND

A gas turbine engine typically includes a fan section, a compressor section, a combustor section, and a turbine section. Air entering the compressor section is compressed and delivered into the combustor section where it is mixed with fuel and ignited to generate a high-speed exhaust gas flow. The high-speed exhaust gas flow expands through the turbine section to drive the compressor and the fan section. The compressor section typically includes low pressure and high pressure compressors, and the turbine section includes low pressure and high pressure turbines.

The compressor and turbine sections include circumferential arrangements of fixed and rotating stages. Structural vibratory coupling between adjacent airfoils can occur during engine operation. For rotating stages of the engine, blade mistuning may be used, in which there are two sets of blades arranged in circumferentially alternating relationships. One set of blades has a different characteristic than the other set of blades to provide two different resonant frequencies. For fixed stages, vanes have been mistuned by providing different sets of vanes in adjacent quadrants of the array.

### SUMMARY

A gas turbine engine component may comprise a disk and a plurality of airfoils coupled to the disk, the plurality of airfoils comprising first airfoils adjacent to an edge of the disk, and second airfoils axially offset from the edge of the disk.

In various embodiments, the plurality of airfoils may comprise rotor blades or stator vanes. The edge of the disk may be an aft edge of the disk. The first airfoils and the second airfoils may alternate around a circumference of the disk. The first airfoils and the second airfoils are randomly positioned around a circumference of the disk. The second airfoils may be offset by a distance of between 1-10% of a chord length of the second airfoils. The gas turbine engine component may comprise third airfoils axially offset from the edge of the disk, wherein the second airfoils are offset by a first distance, and the third airfoils are offset by a second distance.

An airfoil assembly may comprise a disk comprising a forward edge and an aft edge; a first airfoil coupled to the disk, the first airfoil comprising a leading edge and a trailing edge, the leading edge of the first airfoil located adjacent to the forward edge of the disk, and the trailing edge of the first airfoil located adjacent to the aft edge of the disk; and a second airfoil coupled to the disk, the second airfoil comprising a leading edge and a trailing edge, the leading edge of the second airfoil located adjacent to the forward edge of the disk, and the trailing edge of the second airfoil offset from the aft edge of the disk.

In various embodiments, the trailing edge of the second airfoil may be offset from the aft edge of the disk by a distance of between 1-10% of a chord length of the second airfoil. The trailing edge of the second airfoil may be offset by between 0.01-0.1 inches. The trailing edge of the second airfoil may be located forward of the trailing edge of the first airfoil. The disk, the first airfoil, and the second airfoil may be part of an integrally bladed rotor. The first airfoil and the second airfoil may be configured to decrease a wake energy of the airfoil assembly. A plurality of first airfoils and a plurality of second airfoils may alternate around a circumference of the disk.

A rotor assembly may comprise a plurality of first blades each comprising a first trailing edge, and a plurality of second blades each comprising a second trailing edge, wherein the second trailing edges are located forward of the first trailing edges.

In various embodiments, the first blades each comprise a first leading edge and the second blades each comprise a second leading edge, wherein the second leading edges are located axially forward of the first leading edges. The first blades may each comprise a first leading edge and the second blades may each comprise a second leading edge, wherein the second leading edges are circumferentially aligned with the first leading edges. The plurality of first blades and the plurality of second blades may alternate around a circumference of the rotor assembly. The plurality of first blades and the plurality of second blades may be randomly disposed around a circumference of the rotor assembly. The rotor assembly may further comprise a plurality of third blades each comprising a third trailing edge, wherein the third trailing edges are located axially forward of the second trailing edges.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 illustrates a schematic cross-section view of a gas turbine engine in accordance with various embodiments;

FIG. 2 illustrates a rotor assembly with offset trailing edges in accordance with various embodiments;

FIG. 3 illustrates a rotor assembly with offset leading edges in accordance with various embodiments;

FIG. 4A illustrates a schematic view of a disk with alternating offset airfoils in accordance with various embodiments;

FIG. 4B illustrates a schematic view of a disk with randomly offset airfoils in accordance with various embodiments; and

FIG. 4C illustrates a schematic view of a disk with airfoils of multiple offset distances in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

Axially offset airfoils are disclosed herein. The leading edge, the trailing edge, or both may be axially offset for a portion of the airfoils in a disk. By offsetting the airfoils, the downstream wake energy to the next stage of airfoils may be decreased. By staggering airfoils which are offset with airfoils that are not offset, the wake shapes from the airfoils may be out of phase and will not excite the downstream airfoils as much as conventional systems. This may decrease vibration and associated vibratory stresses in the system.

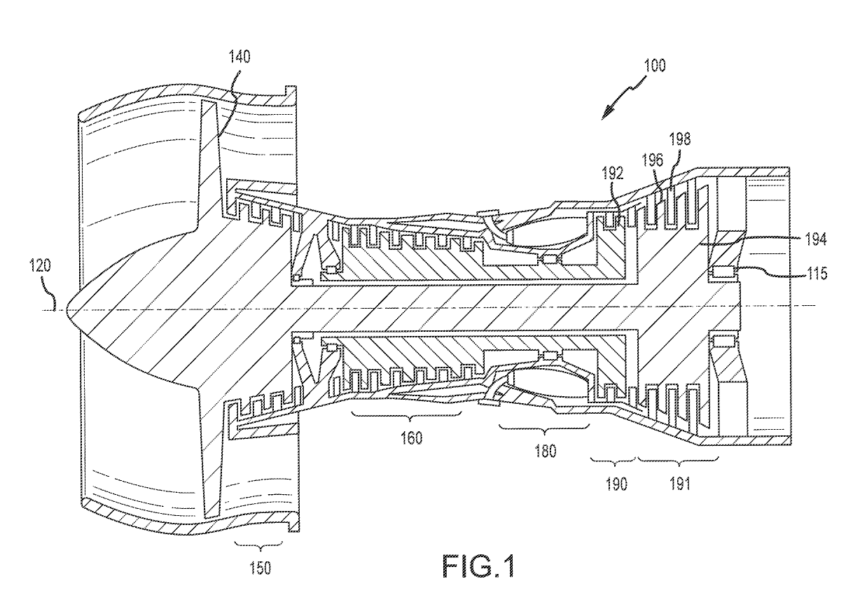

Referring to FIG. 1, a gas turbine engine 100 (such as a turbofan gas turbine engine) is illustrated according to various embodiments. Gas turbine engine 100 is disposed about axial centerline axis 120, which may also be referred to as axis of rotation 120. Gas turbine engine 100 may comprise a fan 140, compressor sections 150 and 160, a combustion section 180 including a combustor, and turbine sections 190, 191. Air compressed in the compressor sections 150, 160 may be mixed with fuel and burned in combustion section 180 and expanded across the turbine sections 190, 191. The turbine sections 190, 191 may include high pressure rotors 192 and low pressure rotors 194, which rotate in response to the expansion. The turbine sections 190, 191 may comprise alternating rows of rotary airfoils or blades 196 and static airfoils or vanes 198. Cooling air may be supplied to the combustor and turbine sections 190, 191 from the compressor sections 150, 160. A plurality of bearings 115 may support spools in the gas turbine engine 100. FIG. 1 provides a general understanding of the sections in a gas turbine engine, and is not intended to limit the disclosure. The present disclosure may extend to all types of turbine engines, including turbofan gas turbine engines (including geared turbofan engines) and turbojet engines, for all types of applications.

The forward-aft positions of gas turbine engine 100 lie along axis of rotation 120. For example, fan 140 may be referred to as forward of turbine section 190 and turbine section 190 may be referred to as aft of fan 140. Typically, during operation of gas turbine engine 100, air flows from forward to aft, for example, from fan 140 to turbine section 190. As air flows from fan 140 to the more aft components of gas turbine engine 100, axis of rotation 120 may also generally define the direction of the air stream flow.

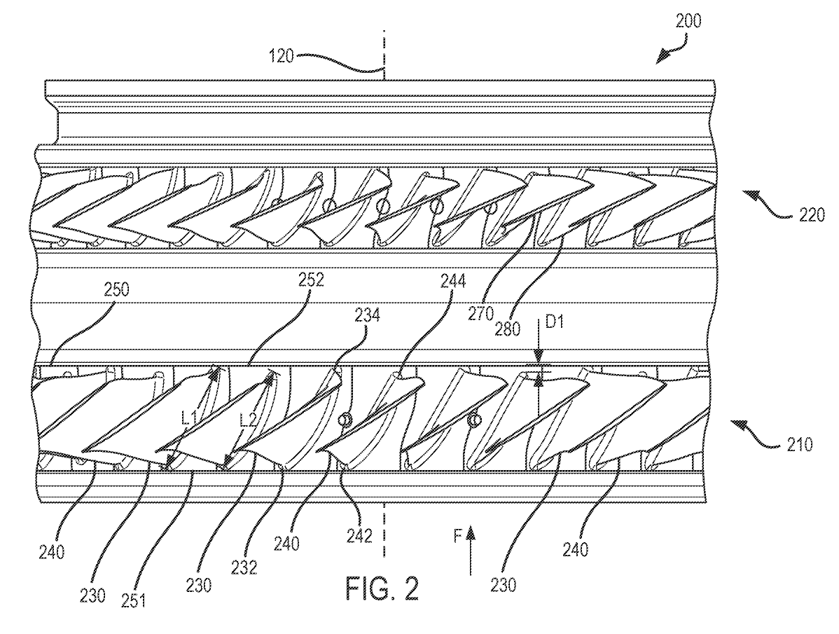

Referring to FIG. 2, an edge on view of a rotor assembly 200 is illustrated according to various embodiments. The rotor assembly 200 is illustrated with a first rotor stage 210 and a second rotor stage 220. The first rotor stage 210 and the second rotor stage 220 rotate about axis of rotation 120. Each rotor stage 210, 220 comprises a plurality of blades coupled to a disk. In various embodiments, each blade may comprise a root which is inserted into a slot in the disk. In various embodiments, the rotor assembly 200 or rotor stages 210, 220 may comprise an integrally bladed rotor (“IBR”), such that the blades and disks are formed from a single integral component. An IBR may be formed using a CNC machine. Arrow F indicates the general direction of airflow through the rotor assembly 200.

The first rotor stage 210 may comprise first blades 230 comprising a leading edge 232 adjacent to a forward edge 251 of the disk 250, and a trailing edge 234 adjacent to an aft edge 252 of the disk 250. The first rotor stage 210 may comprise second blades 240 comprising a leading edge 242, and a trailing edge 244 which is offset from the aft edge 252 of the disk 250. As used herein, the offset is the axial distance between the forward edge of the disk and the leading edge of a blade, or the axial distance between the aft edge of the disk and the trailing edge of a blade. The second blades 240 may comprise a leading edge 242 which is adjacent to the forward edge 251 of the disk 250. Due to the offset, the wake shapes of the first blades 230 and the second blades 240 may be out of phase, and the wake may not excite the downstream airfoils, such as stator vanes between the first rotor stage 210 and the second rotor stage 220, as much as compared to rotor stages without offset blades.

In various embodiments, a chord length L2 of the second blades 240 may be shorter than a chord length L1 of the first blades 230. Thus, the leading edges 232 of the first blades 230 and the leading edges 242 of the second blades 240 may be circumferentially aligned, while the trailing edges 234 of the first blades 230 and the trailing edges 244 of the second blades 240 are not circumferentially aligned, such that the trailing edges 244 of the second blades 240 are located axially forward of the trailing edges 234 of the first blades 230. In various embodiments, the chord length L1 of the first blades 230 and the chord length L2 of the second blades 240 may be equal, and the second blades 240 may be positioned axially forward of the first blades 230, such that the leading edges 242 of the second blades 240 are axially forward of the leading edges 232 of the first blades 230, and the trailing edges 244 of the second blades 240 are axially forward of the trailing edges 234 of the first blades 230.

The trailing edges 244 of the second blades 240 may be offset by a distance D1. In various embodiments, the distance D1 may be between 1-10% of the chord length L2 of the second blades. In various embodiments, the distance D1 may be between 0.01 inches-0.1 inches (0.025 cm-0.25 cm). Similarly to the first rotor stage 210, the second rotor stage 220 may comprise a plurality of offset blades 270, and a plurality of blades 280 which are not offset.

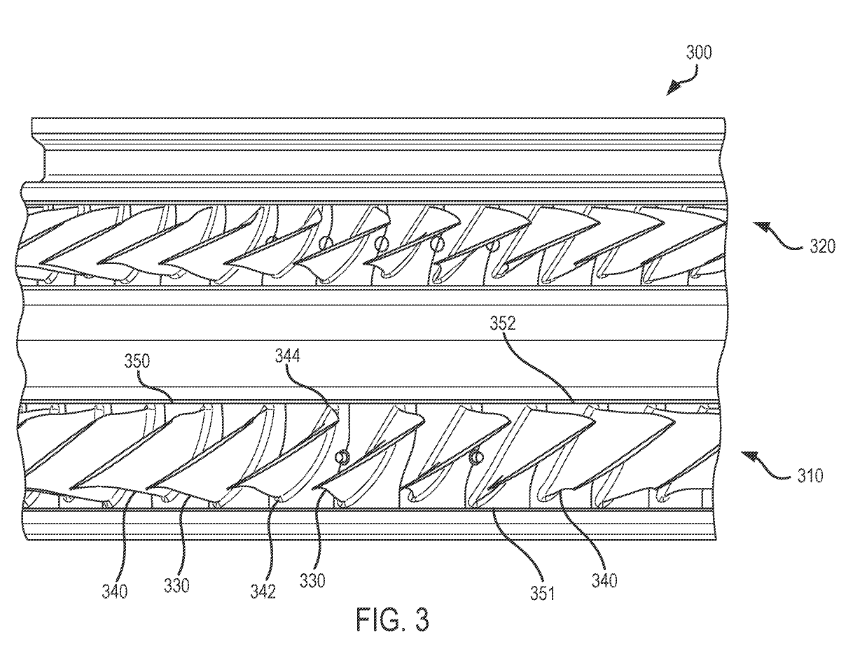

Referring to FIG. 3, an edge on view of a rotor assembly 300 is illustrated according to various embodiments. The rotor assembly 300 is illustrated with a first rotor stage 310 and a second rotor stage 320. Each rotor stage 310, 320 comprises a plurality of blades coupled to a disk.

The first rotor stage 310 may comprise first blades 330 which extend from a forward edge 351 of the disk 350 to an aft edge 352 of the disk 350. The first rotor stage 310 may comprise second blades 340 comprising a leading edge 342 and a trailing edge 344. The leading edges 342 of the second blades 340 are offset from the forward edge 351 of the disk 350. The second blades 340 may comprise a trailing edge 344 which is adjacent to the aft edge 352 of the disk 350. Due to the offset, the bow waves of the first blades 330 and the second blades 340 may be out of phase, and the bow waves may decrease the excitation of adjacent airfoils as compared to conventional rotor stages without offset blades.

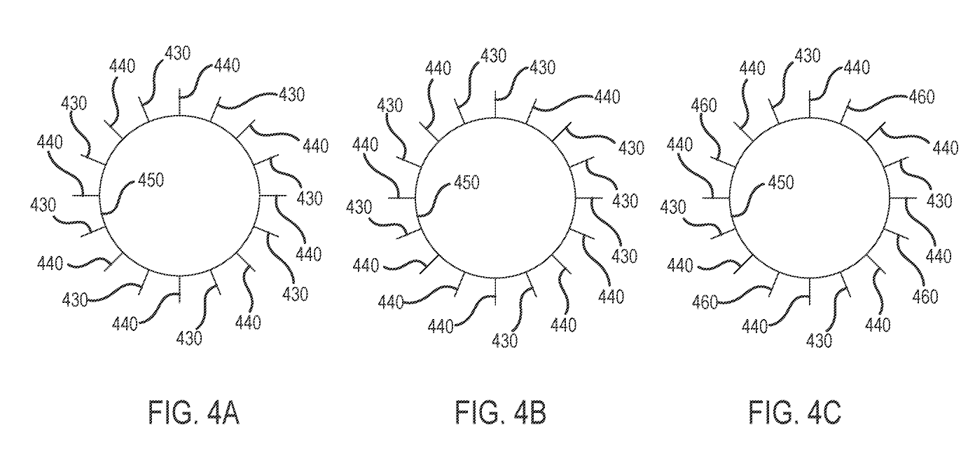

Referring to FIGS. 4A-4C, various schematic configurations for offset airfoils are illustrated according to various embodiments. In FIG. 4A, a rotor disk 450 with alternating blades is illustrated according to various embodiments. The rotor disk may comprise first blades 430 which are not offset, and second blades 440 which are offset. The first blades 430 and the second blades 440 may alternate around the circumference of the rotor disk 450. In FIG. 4B, the first blades 430 and the second blades 440 may be randomly arranged around the circumference of the rotor disk 450. In FIG. 4C, the rotor disk 450 may comprise first blades 430 which are not offset, second blades 440 which are offset by a first distance, and third blades 460 which are offset by a second distance. The blades may follow a pattern of first blade 430, second blade 440, third blade 460, second blade 440 going around the circumference of the rotor disk 450. Those skilled in the art will appreciate that FIGS. 4A-4C represent only a few examples of different patterns of offset blades, and that many other patterns may be consistent with the present disclosure.

Although described primarily with reference to rotor blades, those skilled in the art will recognize that the offset airfoils may similarly be used in stator vanes to decrease vibrations resulting from the wake energy or bow waves in the stator vanes.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A gas turbine engine component comprising:
a disk; and
a plurality of airfoils coupled to the disk, the plurality of airfoils comprising first airfoils adjacent to an edge of the disk, and second airfoils axially offset from the edge of the disk.

2. The gas turbine engine component of claim 1, wherein the plurality of airfoils comprise rotor blades or stator vanes.

3. The gas turbine engine component of claim 1, wherein the edge of the disk is an aft edge of the disk.

4. The gas turbine engine component of claim 1, wherein the first airfoils and the second airfoils alternate around a circumference of the disk.

5. The gas turbine engine component of claim 1, wherein the first airfoils and the second airfoils are randomly positioned around a circumference of the disk.

6. The gas turbine engine component of claim 1, wherein the second airfoils are offset by a distance of between 1% and 10% of a chord length of the second airfoils.

7. The gas turbine engine component of claim 1, further comprising third airfoils axially offset from the edge of the disk, wherein the second airfoils are offset by a first distance, and the third airfoils are offset by a second distance.

8. An airfoil assembly comprising:
a disk comprising a forward edge and an aft edge;
a first airfoil coupled to the disk, the first airfoil comprising a leading edge and a trailing edge, the leading edge of the first airfoil located adjacent to the forward edge of the disk, and the trailing edge of the first airfoil located adjacent to the aft edge of the disk; and
a second airfoil coupled to the disk, the second airfoil comprising a leading edge and a trailing edge, the leading edge of the second airfoil located adjacent to the forward edge of the disk, and the trailing edge of the second airfoil offset from the aft edge of the disk.

9. The airfoil assembly of claim 8, wherein the trailing edge of the second airfoil is offset from the aft edge of the disk by a distance of between 1-10% of a chord length of the second airfoil.

10. The airfoil assembly of claim 8, wherein the trailing edge of the second airfoil is offset by between 0.01 inches and 0.1 inches.

11. The airfoil assembly of claim 8, wherein the trailing edge of the second airfoil is located forward of the trailing edge of the first airfoil.

12. The airfoil assembly of claim 8, wherein the disk, the first airfoil, and the second airfoil are part of an integrally bladed rotor.

13. The airfoil assembly of claim 8, wherein the first airfoil and the second airfoil are configured to decrease a wake energy of the airfoil assembly.

14. The airfoil assembly of claim 8, wherein a plurality of first airfoils and a plurality of second airfoils alternate around a circumference of the disk.

15. A rotor assembly comprising:
a plurality of first blades each comprising a first trailing edge; and
a plurality of second blades each comprising a second trailing edge;
wherein the second trailing edges are located forward of the first trailing edges.

16. The rotor assembly of claim 15, wherein the first blades each comprise a first leading edge and the second blades each comprise a second leading edge, wherein the second leading edges are located axially forward of the first leading edges.

17. The rotor assembly of claim 15, wherein the first blades each comprise a first leading edge and the second blades each comprise a second leading edge, wherein the second leading edges are circumferentially aligned with the first leading edges.

18. The rotor assembly of claim 15, wherein the plurality of first blades and the plurality of second blades alternate around a circumference of the rotor assembly.

19. The rotor assembly of claim 15, wherein the plurality of first blades and the plurality of second blades are randomly disposed around a circumference of the rotor assembly.

20. The rotor assembly of claim 15, further comprising a plurality of third blades each comprising a third trailing edge, wherein the third trailing edges are located axially forward of the second trailing edges.
